(19) United States
(12) Patent Application Publication
(10) Pub. No.: US 2008/0231671 A1
(43) Pub. Date: Sep. 25, 2008

(54) INK-JET IMAGE FORMING APPARATUS AND INK SUPPLY DEVICE THEREOF

(75) Inventors: In Su LEE, Suwon-si (KR); Sung Wook Kang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/019,144

(22) Filed: Jan. 24, 2008

(30) Foreign Application Priority Data
Mar. 21, 2007 (KR) 2007-27731

(51) Int. Cl. B41J 2/175

(52) U.S. Cl. 347/85

(57) ABSTRACT

An image forming apparatus is configured to include an ink supply device with an ink flow path to a print head to eject ink toward a printing medium and a flow regulating valve for the ink flow path. The flow regulating valve to perform opening/closing operations according to at least the ejection amount of ink from a print head. The ink supply device includes a body, which has an ink discharge path coupled to the print head, a first chamber coupled to the ink discharge path, an ink introduction path coupled to the ink tank, a second chamber coupled to the ink introduction path, and a connecting path to coupled the first and second chambers to each other. The flow regulating valve is configured to open or close the connecting path, and a valve drive unit is configured to operate the flow regulating valve.

### CROSS-REFERENCE TO RELATED APPLICATIONS

This application claims priority under 35 U.S.C. 119(a) from Korean Patent Application No. 2007-0027731, filed on Mar. 21, 2007 in the Korean Intellectual Property Office, the disclosure of which is incorporated herein by reference in its entirety.

### BACKGROUND OF THE INVENTION

1. Field of the Invention

The present general inventive concept relates to an ink supply device, an image forming apparatus, and a method thereof, to achieve the stable supply of ink into a print head that injects the ink onto a printing medium.

2. Description of the Related Art

Generally, an image forming apparatus is an apparatus to develop a black-and-white image or color image on a printing medium, such as a sheet of paper, on the basis of an image signal. Examples of the image forming apparatus include a laser printer, an ink-jet printer, a copying machine, a multi-function machine, facsimile, etc. Representative image forming methods of these various kinds of image forming apparatuses may include an electro-photographic method and an ink-jet method. In the electro-photographic method, a light beam is scanned onto a photosensitive member to form an electrostatic latent image, and a developing agent is attached onto the electrostatic latent image to transfer the electrostatic latent image onto a printing medium. In the ink-jet method, liquid-phase ink is injected onto a surface of a printing medium on the basis of an image signal.

An ink-jet image forming apparatus includes a print head that ejects ink on the basis of an image signal. As the print head discharges ink droplets based on the image signal, letters or pictures are printed on a printing medium. The print head of the ink-jet image forming apparatus may be classified into a so-called shuttle type print head and a so-called array print head. The shuttle type print head is spaced apart from a surface of the printing medium by a predetermined distance and is adapted to eject ink while reciprocally moving in a direction orthogonal to the conveyance direction of the printing medium (e.g., the width direction of the printing medium). The array print head has a length equal to a width of the printing medium and can perform a line printing operation. The array print head prints one line at a time and thus may be suitable for a high-speed printing operation.

Both the shuttle type print head and the array print head are arranged to receive ink from an ink tank storing ink therein. When an excessive amount of ink is supplied to the print head during a printing operation or ink is still supplied after the printing operation stops, there a wetting phenomenon may occur in that ink overflows from a surface of the print head regardless of the implementation of the printing operation. To solve this problem, an ink supply device is used to generate a negative pressure between the print head and the ink tank, which allows ink to flow between the ink tank and the print head only while the print head ejects ink.

One example of the above described ink supply device is disclosed in U.S. Patent Publication No. US 2004/0183872 (U.S. Pat. No. 7,040,742 entitled “INK FLOW CONTROL DEVICE FOR INK JET TYPE PRINTER).

The conventional ink supply device, disclosed in U.S. Pat. No. 7,040,742, includes a body having ink flow paths formed therein, an ink supply needle protruding upward from the body to be connected to an ink tank, and a connecting pipe protruding downward from the body to be connected to a print head. The body is internally formed with a valve operating chamber connected to the ink supply needle through the ink flow path and a pressure receiving chamber connected to the connecting pipe through another ink flow path. A pressure regulating valve is installed between the valve operating chamber and the pressure receiving chamber such that the pressure regulating valve comes into close contact with or is separated from a valve seat, for controlling the flow of ink between the valve operating chamber and the pressure receiving chamber. The pressure receiving chamber uses or receives a spring to pull the pressure regulating valve upward such that the pressure regulating valve comes into close contact with the valve seat, and a diaphragm coupled to an upper end of the pressure regulating valve and configured to be bent downward if the pressure of the pressure receiving chamber drops, so as to move the pressure regulating valve downward.

In the conventional ink supply device having the above described configuration, the pressure regulating valve is pulled upward by the spring to come into close contact with the valve seat while no printing operation is performed, thereby preventing ink from flowing from the valve operating chamber into the pressure receiving chamber. Then, if ink is discharged from the connecting pipe via injection of ink from the print head, the pressure of the pressure receiving chamber drops, and thus, the pressure regulating valve is moved downward by operation of the diaphragm. In this case, as the pressure regulating valve is separated from the valve seat, the ink received in the valve operating chamber is introduced into the pressure receiving chamber to allow the supply of ink into the print head.

The above described conventional pressure regulating mechanism, however, has various problems in that the rubber-made pressure regulating valve has a deterioration in contact force with the valve seat as time passes. For example, unwanted leakage of ink from the valve operating chamber into the pressure receiving chamber may occur. To prevent the leakage of ink, if the pressure regulating valve is more strongly forced against the valve seat by increasing the elastic force of the spring (the pressure regulating valve in closer contact with the valve seat), increased or a high pressure is needed to operate the pressure regulating valve, and therefore, it is difficult to supply ink into the print head.

### SUMMARY OF THE INVENTION

The present general inventive concept addresses problems of the conventional art.

The present general inventive concept provides an ink-jet image forming apparatus, which can supply ink into a print head during a printing operation and reduce leaking or prevent ink from leaking otherwise, and an ink supply device included in the image forming apparatus.

The present general inventive concept provides an ink supply device, an ink-jet image forming apparatus and methods thereof that can efficiently supply ink into a print head during a printing operation and reduce ink leaking or prevent ink from leaking through a gap between a flow regulating valve and a valve seat to control the flow of ink even after a long time of use.

The present general inventive concept provides an image forming apparatus that has a configuration to controllably supply ink into a print head, and an ink supply device included in the image forming apparatus.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept may be achieved by providing an ink-jet image forming apparatus including a print head to eject ink onto a printing medium, an ink tank to store the ink, an ink supply device including a body having an ink discharge path connected to the print head, a first chamber connected to the ink discharge path, an ink introduction path connected to the ink tank, a second chamber connected to the ink introduction path, and a connecting path to connect the first and second chambers to each other, a flow regulating valve to open or close the connecting path, and a valve drive unit to operate the flow regulating valve, and a controller to control the valve drive unit.

The body may have a valve seat to contact the flow regulating valve to close the connecting path, and the valve drive unit may linearly move the flow regulating valve such that the flow regulating valve comes into close contact with or is separated from the valve seat.

The ink-jet image forming apparatus may further include a spring to press the flow regulating valves to allow the flow regulating valve to come into close contact with the valve seat.

A shield member may be between the flow regulating valve and the valve drive unit to prevent ink from reaching the valve drive unit.

The valve drive unit may be a solenoid valve.

The valve drive unit may be a cam unit having a valve operating cam to move the flow regulating valve.

The controller may regulate the opening/closing rate or opening/closing time of the flow regulating valve according to the ejection amount of ink from the print head.

The foregoing and/or other aspects and utilities of the present general inventive concept may also be achieved by providing an ink supply device for an ink-jet image forming apparatus including a body having an ink discharge path for the discharge of ink, a first chamber connected to the ink discharge path, an ink introduction path for the introduction of ink, a second chamber connected to the ink introduction path, and a connecting path to connect the first and second chambers to each other, a flow regulating valve to open or close the connecting path, and a valve drive unit to operate the flow regulating valve.

The foregoing and/or other aspects and utilities of the present general inventive concept may also be achieved by providing an ink supply device usable with and ink-jet forming apparatus including a body having a first and second chamber spaced-apart from each other to discharge and receive ink respectively, and a connecting path to connect the first chamber and the second chamber, and a unit to open and close the connecting path.

The body may include an ink discharge path connected to the first chamber, and an ink introduction path connected to the second chamber.

The ink may be supplied to the second chamber through the ink introduction path in a direction, and the ink may be discharged from the first chamber through the ink discharge path in another direction different from the direction.

The first chamber may be disposed on a position higher than the second chamber.

The connecting path may be disposed in a vertical direction.

The first chamber may have a first volume larger than a second volume of the second chamber.

The foregoing and/or other aspects and utilities of the present general inventive concept may also be achieved by providing an inkjet image forming apparatus including a print head, an ink tank to store ink, and an ink supply device to supply the stored ink to the print head including a body having a first and second chamber spaced-apart from each other to discharge and receive ink respectively, and a connecting path to connect the first chamber and the second chamber, and a unit to open and close the connecting path.

### BRIEF DESCRIPTION OF THE DRAWINGS

These and/or other aspects and utilities of embodiments of the present general inventive concept will become apparent and more readily appreciated from the following description of the embodiments, taken in conjunction with the accompanying drawings, of which:

FIG. 1 is a side sectional diagram schematically illustrating an ink-jet image forming apparatus in accordance with an embodiment of the present general inventive concept;

FIG. 2 is a side sectional diagram illustrating an ink supply device for an image forming apparatus in accordance with an embodiment of the present general inventive concept;

FIG. 3 is a side sectional diagram illustrating operation of the ink supply device for an image forming apparatus in accordance with an embodiment of the present general inventive concept;

FIGS. 4 and 5 are side sectional diagrams illustrating configuration and operation of an ink supply device for an image forming apparatus in accordance with another embodiment of the present general inventive concept;

FIG. 6 is a side sectional diagram illustrating an ink supply device for an image forming apparatus in accordance with yet another embodiment of the present general inventive concept; and

FIGS. 7 and 8 are side sectional diagrams illustrating configuration and operation of an ink supply device for an image forming apparatus in accordance with still yet another embodiment of the present general inventive concept.

### DETAILED DESCRIPTION OF EMBODIMENTS

Reference will now be made in detail to an image forming apparatus in accordance with exemplary embodiments of the present general inventive concept, examples of which are illustrated in the accompanying drawings, wherein like reference numerals refer to like elements throughout. The embodiments are described below to explain the present general inventive concept by referring to the figures.

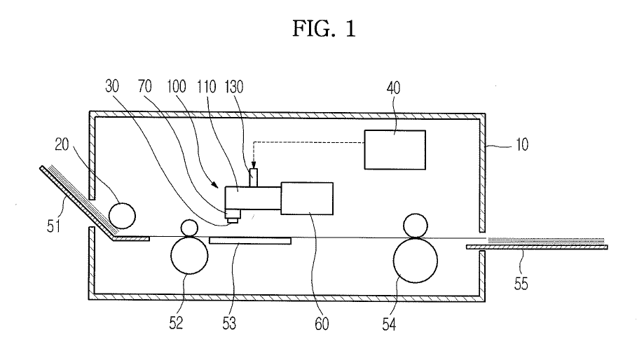

As shown in FIG. 1, an image forming apparatus in accordance with an embodiment of the present general inventive concept may include an image forming apparatus body 10, a pickup device 20 to pick up a printing medium one by one, a print head 30 to eject or inject ink onto the printing medium being conveyed to form an image, an ink supply device 100 to supply ink into the print head 30, and a controller 40 to control operations of a variety of drive elements. In addition, the image forming apparatus body 10 may include a printing medium supply panel 51 on which the printing medium is loaded, a feeding roller 52 to convey the picked-up printing medium to the print head 30, a platen 53 located below the print head 30 and to support the printing medium being conveyed, a discharge roller 54 to discharge the printing medium undergoing a printing operation, and a printing medium discharge panel 55 on which to load the printing medium to be discharged.

In the ink-jet image forming apparatus in accordance with the embodiment of the present general inventive concept illustrated in FIG. 1, if the pickup device 20 picks up the printing medium one by one, which is loaded on the printing medium supply panel 51, the feeding roller 52 conveys the picked-up printing medium to the platen 53. Then, if the printing medium reaches the platen 53, the print head 30 ejects ink onto the printing medium being conveyed based on an image signal to form an image on a surface of the printing medium. The printing medium, having passed through the print head 30, the printing medium is guided to the printing medium discharge panel 55 by the discharge roller 54.

While the print head 30 ejects ink onto the printing medium on the basis of the image signal, the ink supply device 100 supplies the ink, which is stored in an ink tank 60, into the print head 30. It is noted that a printing defect may occur when an insufficient amount of ink is supplied into the print head 30, or the ink may overflow from the surface of the print head 30 when an excessive amount of ink is supplied. Therefore, the ink supply device 100 has to be designed to supply an appropriate amount of ink according to the ejection amount of ink from (e.g., output by) the print head 30. An ink channel unit 70 to guide the supply of ink into the print head 30 is installed between the print head 30 and the ink supply device 100. The ink channel unit 70 may serve to evenly supply the ink into a plurality of nozzles (not shown) provided in the print head 30. The ink channel unit 70 may be internally formed with an ink flow path (not shown) for the flowing of ink.

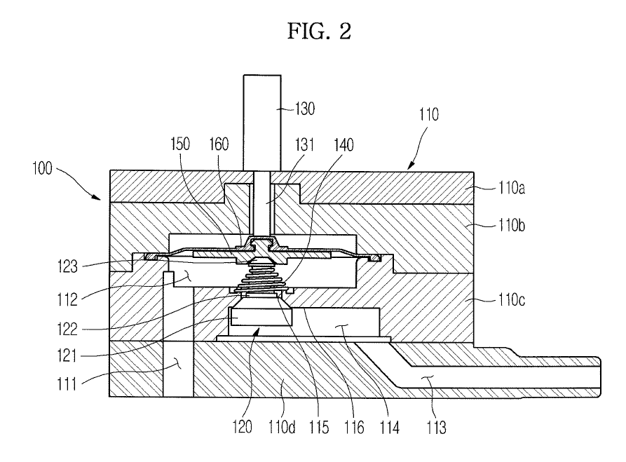

The ink supply device 100, as illustrated in FIG. 2, includes a body 110 having an ink flow path formed therein, a flow regulating valve 120 to regulate the flow of ink through the inner flow path of the body 110, and a solenoid valve 130 to operate the flow regulating valve 120.

The body 110 is formed by stacking a plurality of plates 110a, 110b, 110c, and 110d one above another. The body 110 is internally include an ink discharge path 111, an ink introduction path 113, a first chamber 112, and a second chamber 114. Also, a connecting path 115 is formed between the first chamber 112 and the second chamber 114 for the passage of ink. The connecting path 115 is opened or closed by the flow regulating valve 120. The ink discharge path 111 can connect the first chamber 112 to the ink channel unit 70, and the ink introduction path 113 can connect the second chamber 114 to the ink tank 60. Accordingly, the ink stored in the ink tank 60 of FIG. 2 is first introduced into the second chamber 114 through the ink introduction path 113, and thereafter, is supplied into the ink channel unit 70 through the connecting path 115, the first chamber 112, and the ink discharge path 111 in sequence.

Each of the first and second chambers 112 and 114 has a size suitable to temporarily store a predetermined amount of ink therein. For example, the predetermined amount of ink may be based in part on the specific image forming device. A valve seat 116 is located between the first chamber 112 and the second chamber 114 such that the valve seat 116 can come into close contact with the flow regulating valve 120 (e.g., to close the connecting path 115). Inn one embodiment, the valve seat may be positioned at ends, between the ends or along the connecting path or elsewhere in the ink flow path. The first chamber 112 may install a shield member 160 to prevent the ink stored in the first chamber 112 from flowing to the solenoid valve 130, and a spring 140 to press (e.g., urge) the flow regulating valve 120 upward to allow the flow regulating valve 120 to come into close contact with the valve seat 116. A head portion 121 of the flow regulating valve 120 is preferably disposed in the second chamber 114 and adapted to close the connecting path 115 (e.g., one end) when it comes into close contact with the valve seat 116.

The flow regulating valve 120 is movable (e.g., vertically or angled) within the body 110 such that it comes into close contact with the valve seat 116 for closing the connecting path 115. The flow regulating valve 120 has the head portion 121 having a width larger than that of the connecting path 115, a connecting portion 122 to extend from the head portion 121 toward the first chamber 112 to penetrate through the connecting path 115, and an expanded portion 123 provided at an end of the connecting portion 122. The expanded portion 123 may be coupled to an end of the spring 140. In one embodiment, the expanded portion may be omitted and the spring can be coupled to a connecting portion of a flow regulating valve. As the spring 140 presses the expanded portion 123 upward, the head portion 121 of the flow regulating valve 120 comes into close contact with the valve seat 116, and the connecting path 115 is closed. The spring 140 may be supported by the valve seat 116 or other components of the ink supply device. The head portion 121 may be made of an elastic material or the like, such as rubber, to close the connecting path 115 (e.g., with high stability).

A pressure member 150 may be coupled to an upper end of the expanded portion 123. The pressure member 150 serves to transmit a pressure force of the solenoid valve 130 to the flow regulating valve 120. The shield member 160 is coupled to an upper end of the pressure member 150 to reduce or prevent leakage of the ink stored in the first chamber 112 to the outside. The pressure member 150 for transmitting a pressure force of the solenoid valve 130 to the flow regulating valve 120 is made of a hard material so as not to be easily deformed by an external force. The shield member 160 is made of a rubber, a thin metal plate, or other elastically restorable materials.

The solenoid valve 130 is a power-operating type, similar to conventional solenoid valves. The solenoid valve 130 has an operating shaft 131, which is moved in a sliding manner (e.g., vertically) to push the pressure member 150. If power is applied to the solenoid valve 130, the operating shaft 131 may push the pressure member 150 from the upper side of the shield member 160 to cause the flow regulating valve 120 to be moved downward. If the supply of power to the solenoid valve 130 is interrupted, the spring 150, which was pushed and compressed by the operating shaft 131, is elastically restored to cause the operating shaft 131 to be returned (e.g., upward) to its original position.

Operations of the solenoid valve 130 having the above described configuration is controlled by the controller 140. During a printing operation, the controller 40 receives information about the amount of ink ejected from the print head 30 and control the operation of the solenoid valve 130 in response to the information to regulate the opening/closing rate or opening/closing time of the flow regulating valve 120. For example, in the case where a printing object is a picture, the opening/closing rate of the flow regulating valve 120 is raised or the opening/closing time is extended to increase the amount of ink to be supplied into the print head 30. In the case where a printing object is a letter, the opening/closing rate of the flow regulating valve 120 is lowered or the opening/closing time is shortened to reduce the amount of ink to be supplied into the print head 30. In accordance with such operations, the ink channel unit 70 can keep a constant pressure drop or substantially constant pressure drop regardless of the ejection amount of ink from the print head 30, and the resulting image may have high uniformity.

Operations of the ink supply device 100 for the ink-jet image forming apparatus in accordance with the first embodiment of the present general inventive concept will be described.

As illustrated in FIG. 2 while a printing operation is not performed, the head portion 121 of the flow regulating valve 120 comes into close contact with the valve seat 116 by the elastic force of the spring 140, and the connecting path 115 between the first chamber 112 and the second chamber 114 is closed. In this case, preferably no ink flow occurs between the first chamber 112 and the second chamber 114.

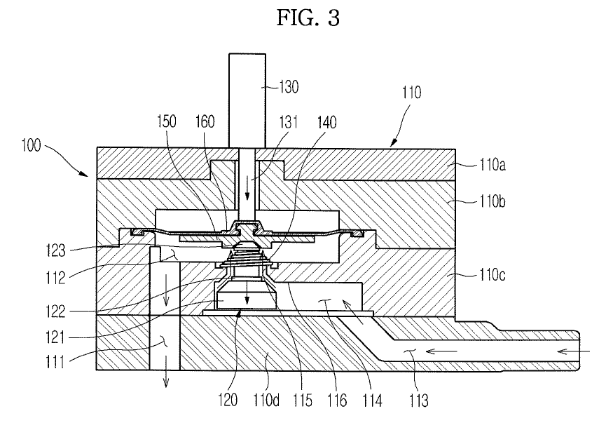

If a printing command is applied from an external computer (not shown), a printing medium is supplied toward the print head 30, and the controller 40 may calculate the amount of ink to be ejected according to an image signal and/or the opening rate of the flow regulating valve 120 or the like to control operations of both the print head 30 and the solenoid valve 130. On the basis of the calculated values, the print head 30 ejects ink onto the printing medium on the basis of the image signal, and the operation of the solenoid valve 130 begins. As illustrated in FIG. 3, the operating shaft 131 of the solenoid valve 130 is moved downward to press the pressure member 150 downward. As the pressure member 150 is pressed downward, the flow regulating valve 120 is pushed downward to cause the spring 140 to be compressed and the head portion 121 of the flow regulating valve 120 to be separated from the valve seat 116. Thereby, the connecting path 115 is opened, and the ink in the second chamber 114 is introduced into the first chamber 112 through the connecting path 115. As the ink is ejected from the print head 30, the ink flow path provided in the ink channel unit 70 has a pressure drop. With the pressure drop of the ink flow path, the ink in the first chamber 112 is preferably supplied into the ink channel unit 70 through the ink discharge path 111.

While the printing operation is in progress, the controller 40 operates the solenoid valve 130 on the basis of the ejection amount of ink from the print head 30 so as to regulate the opening/closing rate or opening/closing time of the flow regulating valve 120. In this manner, the efficient supply of ink into the print head 30 may be provided.

Once the printing operation is completed and the print head 30 stops the ejection of ink, the supply of power to the solenoid valve 130 is preferably interrupted, and the operating shaft 131 and the flow regulating valve 120 are moved upward by the elastic force of the spring 140. In this case, the head portion 121 again comes into close contact with the valve seat 116, and the connecting path 115 is closed.

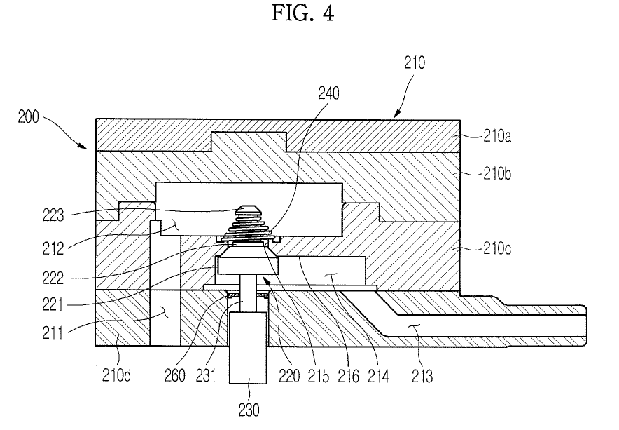

FIG. 4 is a side sectional diagram illustrating an ink supply device 200 for an ink-jet image forming apparatus in accordance with another embodiment of the present general inventive concept.

Portions of the configuration of the ink supply device 200 for the ink-jet image forming apparatus in accordance with the embodiment illustrated in FIG. 4 are identical to those of the ink supply device 100 of the embodiment of FIG. 1. However, in the second embodiment illustrated in FIG. 4, a solenoid valve is disposed in a lower region of a body.

The ink supply device 200 for the ink-jet image forming apparatus in accordance with the present general inventive concept includes a body 210 in the form of a stack of a plurality of plates 210a, 210b, 210c, and 210d, a flow regulating valve 220 installed in the body 210 to regulate the flow of ink, and a solenoid valve 230 to operate the flow regulating valve 220.

The body 110 may be formed with an internal ink discharge path 211 coupled to a print head (e.g., print head 30, See FIG. 1), a first chamber 212 coupled to the ink discharge path 211, an ink introduction path 213 coupled to an ink tank (e.g., ink tank 60, See FIG. 1), a second chamber 214 coupled to the ink introduction path 213, and a connecting path 215 to coupled the first and second chambers 212 and 214 to each other.

The flow regulating valve 220 is reciprocally movable within the body 210 to open or close the connecting path 215. The flow regulating valve 220 may have a head portion 221 disposed in the second chamber 214 to contact a valve seat 216 located between the first chamber 212 and the second chamber 214, an expanded portion 223 disposed in the first chamber 212, and a connecting portion 222 to couple the head portion 221 and the expanded portion 223 to each other. The head portion 221 is made of rubber such that it can securely come into close contact with the valve seat 216. The expanded portion 223 is coupled to a spring 240, which may be installed in the first chamber 212 and supported by the valve seat 216. The spring 240 serves to press or urge the flow regulating valve 220 upward.

The solenoid valve 230 is controlled by a controller (e.g., the controller 40, See FIG. 1), and may be installed below the flow regulating valve 220 to pull the flow regulating valve 220 downward. The solenoid valve 230 has an operating shaft 231 to extend into the second chamber 214 to be coupled to the flow regulating valve 220. A shield member 260 may be coupled around the operating shaft 231 at a prescribed position of the operating shaft 231. For example, the shield member 260 can closely contact with the outer periphery of the operating shaft 231 to prevent ink stored in the second chamber 214 from leaking toward the solenoid valve 230. The shield member 260 may be made of an elastic material that is deformable during a movement (e.g., vertical) of the operating shaft 231.

In the ink supply device 200 for the ink-jet image forming apparatus in accordance with another embodiment of the present general inventive concept, when ink is ejected from the print head 30, the solenoid valve 230 regulates the opening/closing rate or opening/closing time of the flow regulating valve 220 according to the ejection amount of ink. Accordingly, the ink stored in the first chamber 212 may be efficiently supplied into the print head 30.

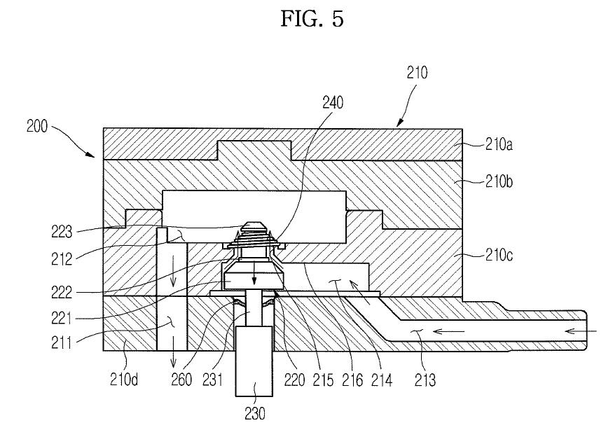

As shown in FIG. 5, if power is applied to the solenoid valve 230, the operating shaft 231 may controllably be moved downward to pull the flow regulating valve 220 downward. In this case, the spring 240 is compressed, and the head portion 221 of the flow regulating valve 220 is separated from the valve seat 216. Thereby, the ink in the second chamber 214 is introduced into the first chamber 212 through the opened connecting path 215, and sequentially, the ink in the first chamber 212 is supplied into the print head 30 through the ink discharge path 211.

Once the printing operation is completed and the print head 30 stops ejecting ink, the supply of power to the solenoid valve 230 is interrupted (e.g., stopped), and the spring 140 is elastically restored, which can cause the head portion 221 of the flow regulating valve 220 to again come into close contact with the valve seat 216 and the connecting path 115 to be closed.

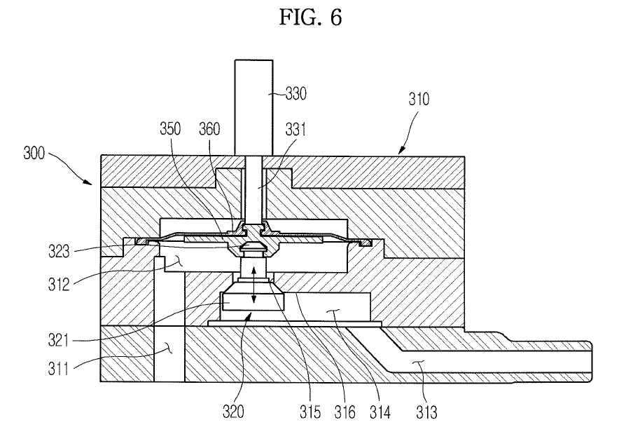

FIG. 6 is a side sectional diagram illustrating an ink supply device 300 for the ink-jet image forming apparatus in accordance with yet another embodiment of the present general inventive concept.

Portions of the configuration of the ink supply device 300 for the ink-jet image forming apparatus in accordance with the embodiment illustrated in FIG. 6 are identical to those of the ink supply device 100 embodiment. Accordingly, a detailed description thereof will be omitted here.

The ink supply device 300 embodiment for the ink-jet image forming apparatus in accordance with the present general inventive concept may include a body 310 having an ink introduction path 313 and an ink discharge path 311, a flow regulating valve 320 included in the body 310, and a solenoid valve 330 to operate the flow regulating valve 320.

The body 310 may internally include the ink discharge path 311, a first chamber 312, a connecting path 315, a second chamber 314, and an ink introduction path 313, which are sequentially coupled to one another. The flow regulating valve 320 may have a head portion 321 having a dimension larger than that of the connecting path 315. The flowing regulating valve 320 may be slidingly movable within the body 310 such that the head portion 321 comes into close contact with a valve seat 316 located between the first chamber 312 and the second chamber 314.

The solenoid valve 330 has a slidingly movable operating shaft 331, which is coupled to a pressure member 350 (e.g., installed in the first chamber 312). The pressure member 350 may be coupled to the expanded portion 323 of the flow regulating valve 320. If the operating shaft 331 is moved, the pressure member 350 and the solenoid valve 330 may be moved together. A shield member 360 coupled to an upper end of the pressure member 350 serves to prevent (e.g., reduce) ink stored in the first chamber 312 from leaking toward the solenoid valve 330.

Operations of the ink supply device 300 for the ink-jet image forming apparatus in accordance with the third embodiment of the present general inventive concept will now be described. As illustrated in FIG. 6, when no ink is ejected (e.g., from the print head 30, See FIG. 1), the solenoid valve 330 is kept stationary in a state where the solenoid valve 330 is set to pull the flow regulating valve 320 upward into contact with the valve seat 316. Thereby, the connecting path 315 is in a closed state.

Then, if a printing operation begins and ink is ejected from the print head 30, the flow regulating valve 320 may be moved downward by the solenoid valve 330 to open the connecting path 315. The solenoid valve 330 may regulate the opening/closing rate and opening/closing time of the flow regulating valve 320 according to the amount of ink (e.g., an image signal). Thus, the efficient supply of ink into the print head 30 is guaranteed.

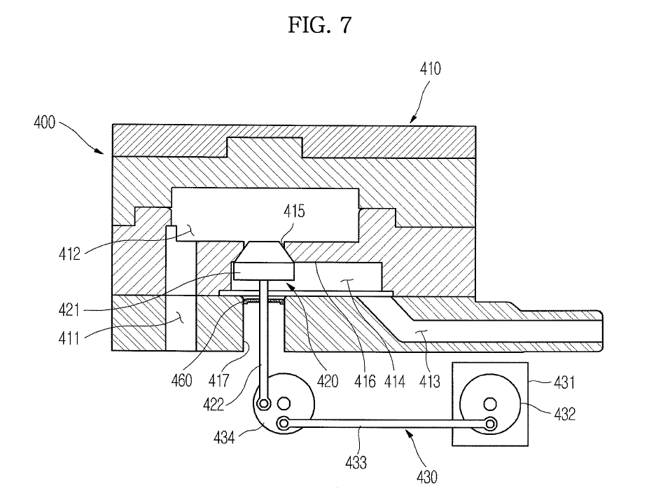

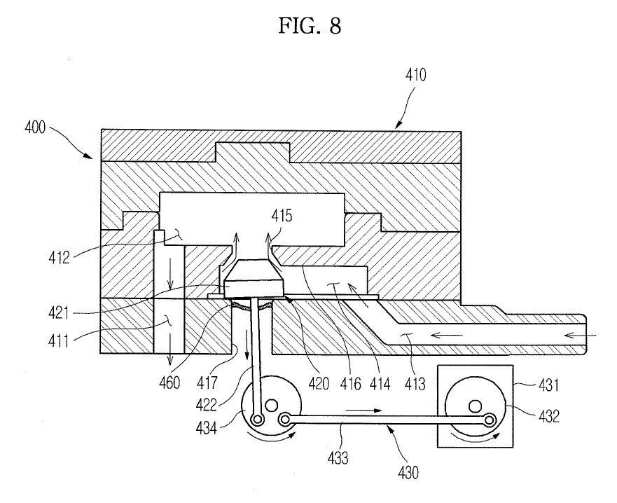

FIGS. 7 and 8 are side sectional diagrams illustrating a configuration and operation of an ink supply device 400 for the image forming apparatus in accordance with another embodiment of the present general inventive concept.

The ink supply device 400 embodiment for the image forming apparatus in accordance with the present general inventive concept may include a body 410 having an ink introduction path 413 and an ink discharge path 411, a flow regulating valve 420 installed in the body 410, and a cam unit 430 to operate the flow regulating valve 420.

The body 410 may be internally formed with the ink discharge path 411, a first chamber 412, a connecting path 415, a second chamber 414, and an ink introduction path 413, which are preferably coupled to one another in sequence. The flow regulating valve 420 has a head portion 421 having a width larger than that of the connecting path 415. The flow regulating valve 420 is movable (e.g. vertically) within the body 410 such that the head portion 421 comes into close contact with a valve seat 416 preferably located between the first chamber 412 and the second chamber 414. A valve shaft 422 may be formed at or coupled to (e.g., a lower end) the head portion 421. The valve shaft 422 may protrude out of the body 410 through an opening 417 formed in the body 410. The opening 417 may install a shield member 460 to reduce or prevent leakage of ink stored in the body 410. The shield member 460 comes into close contact with the outer periphery of the valve shaft 422 to surround the valve shaft 422. The shield member 460 may be made of an elastically deformable material, such as rubber, such that the shield member 460 can be deformed and remain in close contact with the valve shaft 422 during a movement of the valve shaft 422.

The cam unit 430 may include a motor 431, a drive cam 432 provided in the motor 431, a drive shaft 433 having one end coupled (e.g., operably or hingedly) to the drive cam 432, and a valve operating cam 434 to which the other end of the drive shaft 433 and one end of the valve shaft 422 are coupled (e.g., operably or hingedly). The motor 431 may operate (e.g., rotate) forward and reverse, and is preferably controlled by a controller (e.g., controller 40, See FIG. 1). If the drive cam 432 is rotated by operation of the motor 431, a rotating force of the drive cam 432 is transmitted to the valve operating cam 434 through the drive shaft 433. Thereby, the valve operating cam 434 is rotated in the same direction as a rotating direction of the drive cam 432. As the valve operating cam 434 is rotated, the valve shaft 422 is moved vertically, and consequently, the head portion 421 of the flow regulating valve 420 may be operated to open or close the connecting path 415.

Operations of the ink supply device 400 for the ink-jet image forming apparatus in accordance with the embodiment illustrated in FIGS. 7-8 will now be described. When ink is not ejected from the print head, the cam unit 430 is kept stationary in a state that the cam unit 430 forces or presses the flow regulating valve 420 (e.g., upward) to allow the flow regulating valve 420 to come into close contact with the valve seat 416. Thereby, the connecting path 415 is in a closed state.

When a printing operation begins and ink is ejected from the print head 30, as illustrated in FIG. 8, the motor 431 may be operated to rotate the drive cam 432 in reverse (e.g., counterclockwise) by a predetermined angle (for example, 90 degrees). In this case, the drive shaft 433 may be moved (to the right in FIG. 8) to rotate the valve operating cam 434 in reverse by a predetermined angle. As the valve operating cam 434 is rotated, the valve shaft 422 may be correspondingly moved (e.g., downward) to cause the head portion 421 of the flow regulating valve 420 to be separated from the valve seat 416 and the connecting path 415 to be opened. During a movement of the valve shaft 422, the shield member 460 is preferably elastically deformed while surrounding the valve shaft 422 so as to seal the opening 417. Accordingly, there is no or reduced risk of leakage of ink through the opening 417.

While the ink is ejected from the print head 30, the connecting path 415 is opened to supply the ink into the print head 30. Also, while a printing operation is performed, the controller 40 may control the rotation of the drive cam 432 on the basis of an image signal so as to appropriately regulate the opening rate of the flow regulating valve 420. Accordingly, an appropriate amount of ink may be supplied into the print head 30 with high efficiency.

It will be appreciated that a valve drive unit to operate the flow regulating valve is not intended to be limited to the solenoid valve or cam unit as described in the above embodiments, and for example, may be embodied by use of a linear motor, a ball screw, or other various motor devices capable of controllably moving (e.g., vertically, angled, linearly or the like) the flow regulating valve.

Further, it will be appreciated that the present general inventive concept is applicable to all kinds of ink-jet image forming apparatuses (e.g., a shuttle type print head or array print head).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, the present general inventive concept provides embodiments of an ink supply device for an ink-jet image forming apparatus in which a flow regulating valve of the ink supply device can be opened or closed by a valve drive unit that is controlled by a controller. With such a configuration, embodiments of the flow regulating valve may have no deterioration or reduced deterioration in contact force even after an extended or long period of use, and can perform opening/closing operations according to at least the ejection of ink. Further, embodiments of the flow regulating valve may eject ink from a print head with high efficiency, and/or achieve stable supply of the ink into a print head.

Although a few embodiments of the present general inventive concept have been illustrated and described, it would be appreciated by those skilled in the art that changes may be made in these embodiments without departing from the principles and spirit of the general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. An ink-jet image forming apparatus comprising:
a print head to eject ink onto a printing medium;
an ink tank to store the ink;
an ink supply device including a body having an ink discharge path connected to the print head, a first chamber connected to the ink discharge path, an ink introduction path connected to the ink tank, a second chamber connected to the ink introduction path, and a connecting path to connect the first and second chambers to each other, a flow regulating valve to open or close the connecting path; and a valve drive unit to operate the flow regulating valve; and
a controller to control the valve drive unit.

2. The ink-jet image forming apparatus according to claim 1, wherein the body has a valve seat to contact the flow regulating valve to close the connecting path, and the valve drive unit linearly moves the flow regulating valve such that the flow regulating valve comes into close contact with or is separated from the valve seat.

3. The ink-jet image forming apparatus according to claim 2, further comprising:
a spring to press the flow regulating valve, so as to allow the flow regulating valve to come into close contact with the valve seat.

4. The ink-jet image forming apparatus according to claim 2, comprising a shield member between the flow regulating valve and the valve drive unit to prevent ink from reaching the valve drive unit.

5. The ink-jet image forming apparatus according to claim 2, wherein the valve drive unit is a solenoid valve.

6. The ink-jet image forming apparatus according to claim 2, wherein the valve drive unit is a cam unit having a valve operating cam to move the flow regulating valve.

7. The ink-jet image forming apparatus according to claim 1, wherein the controller regulates the opening/closing rate or opening/closing time of the flow regulating valve according to the amount of ink used by the print head.

8. An ink supply device usable with an ink-jet image forming apparatus, comprising:
a body having an ink discharge path for the discharge of ink, a first chamber connected to the ink discharge path, an ink introduction path for the introduction of ink, a second chamber connected to the ink introduction path, and a connecting path to connect the first and second chambers to each other;
a flow regulating valve to open or close the connecting path; and
a valve drive unit to operate the flow regulating valve.

9. The ink supply device according to claim 8, wherein the body has a valve seat to contact with the flow regulating valve to close the connecting path, and the valve drive unit linearly moves the flow regulating valve such that the flow regulating valve comes into close contact with or is separated from the valve seat.

10. The ink supply device according to claim 9, further comprising:
a spring to press the flow regulating valve, so as to allow the flow regulating valve to come into close contact with the valve seat.

11. The ink supply device according to claim 9, comprising:
a shield member installed between the flow regulating valve and the valve drive unit, to prevent ink, flowing within the body, from reaching the valve drive unit.

12. The ink supply device according to claim 9, wherein the valve drive unit is a solenoid valve.

13. The ink supply device according to claim 9, wherein the valve drive unit is a cam unit having a valve operating cam to move the flow regulating valve.
